(19) United States
(12) Patent Application Publication
(10) Pub. No.: US 2004/0236625 A1
(43) Pub. Date: Nov. 25, 2004

(54) Method apparatus and computer program for generating and evaluating feelback from a plurality of respondents

(76) Inventor: John Victor Kearon, Kettering Northants (GB)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/480,396

(22) PCT Filed: Jun. 7, 2002
(86) PCT No.: PCT/GB02/02703

(30) Foreign Application Priority Data
Jun. 8, 2001 (GB) 0114036.7

(51) Int. Cl. G06F 17/60

(52) U.S. Cl. 705/10; 707/1

(57) ABSTRACT

A method of generating and evaluating feedback from a plurality of respondents requests associations from the respondents to a given subject item description. The associations may be given as selections from a list of associations given by previous respondents or as free input. An evolutionary algorithm maintains the list of associations from which the respondents may select. Associations that are selected by subsequent respondents are promoted in the list and those not selected dropped.

The present invention relates to the automated generation and evaluation of feedback from respondents on any given subject, in particular but not exclusively via an electronic communication system such as the Internet.

In many industries, particularly those providing goods and services to the general public, generating and evaluating feedback is the basic mechanism for successfully marketing their wares. To do this it is desirable to understand the opinions, needs and desires of your customers and potential customers, create ideas to match and identify which ideas would be most popular. There is a considerable industry in carrying out such market research, idea creation and concept testing.

One of the most commonly used tools for obtaining feedback from respondents is the questionnaire, which takes a number of forms but generally comprises a structured series of questions about the topic on which opinions are being sought. The questions may be put to the respondent on paper, verbally (e.g. in a telephone, street or house-to-house poll) or electronically and mainly require the respondent to select from a set of proposed answers or occasionally allow any answer to be given (free input). The respondent may also be asked to score a product or concept or to rank a set of items in order according to a specified criterion. The respondent may also be asked to score a product or concept or to rank a set of items in order according to a specified criterion.

To write such a structured questionnaire takes a considerable amount of effort and skill and inherently has the danger that the prejudices of the author will be apparent, deliberately or accidentally, in the phrasing of the questions and the selection of proposed answers from which the respondent is allowed to pick. Also, a significant amount of time, e.g. 20 to 30 minutes, can be required to answer a questionnaire, which is off-putting to respondents and may cause them to answer randomly rather than with due consideration for the correct response. Also, a significant amount of time (often several man-days) is required to collate, structure, interpret and present the results, especially if open-ended questions have been asked. Presenting a questionnaire electronically can reduce the time to collate the answers to pre-coded questions but does not speed up the questionnaire itself nor greatly assist in interpretation of the results, nor reduce the effort required to write the questionnaire in the first place.

A very commonly used method of obtaining ideas is to run a brainstorming session with colleagues, which takes a number of forms but generally comprises a facilitator asking the group for innovative ideas to match a brief. Creative thinking exercises may be employed to help the group come up with novel ideas. Such sessions require a great deal of planning, organization and skill to facilitate and at least an hour of more of the group's time. Since good ideas can come from anywhere, the ideal would be to run such sessions with as wide a group of people as possible but the time, effort and cost of doing this would make it prohibitive.

Once ideas have been generated it is often desirable to evaluate them and for this purpose, concept testing can be employed. Concept testing takes a number of forms but generally involves presenting respondents with a number of concepts, establishing their preferences and reasons behind them. Questions may be put to the respondent on paper, verbally (e.g. in a telephone, street or hall test) and may require the respondent to select from a set of proposed answers or allow any answer to be given (free input). The respondent may also be asked to score a product or concept or to rank a set of items in order according to a specified criterion. Such a procedure suffers from similar problems as research using questionaries.

Accordingly, it is an aim of the invention to provide an improved automated method of carrying out market research, idea generation and concept testing that is quicker and easier to set up and for respondents to complete, removes the need for specialist research or facilitation skills, is carried out remotely and automatically conducts, collates, structures and presents the results for immediate use.

According to the present invention, there is provided an automated method for generating and evaluating feedback from a plurality of respondents, the method comprising the steps of:

providing a database containing at least one subject item, a first plurality of ideas associated with said subject item, and a ranking of said associated ideas;

presenting to one of said respondents said subject item and a second plurality of associated ideas with said subject item, said second plurality comprising a subset of said first plurality based on said ranking;

receiving from said respondent an input comprising a selection from said second plurality of associated ideas or a free input;

updating said database by:

in the case that said input is a selection from said second plurality of associated ideas, increasing the ranking of the selected associated idea, or

in the case that said input is a free input, adding said free input as a new associated idea; and

repeating the steps of presenting, receiving and updating to generate and evaluate feedback from said plurality of respondents.

The present invention makes use of the associative way in which information id held in the brain and an interactive evolutionary algorithm to extract and evaluate the information that is easy to set up, facilitates itself, is self-organising, is inherently bias-free and produces real-time results. An evolutionary algorithm or process requires two steps—blind variation, a creative, generative step, and selective retention, a reductive, evaluative step. In the present invention, blind variation is provided by the ability of a respondent to provide free input, e.g. a new association to the subject presented or a new idea. Selective retention is provided by the selection and increased ranking, effectively reinforcement, given to existing associations when selected in preference to the other existing associations or the option to give free input, and the choice of the subset of existing associations for presentation to the next respondent on the basis of rank. The result being the generation and evaluation of popular opinions and ideas. Because no central moderator is used, unlike known focus group techniques, the risk of bias imparted by a moderator is eliminated. The collective view of the respondents emerges naturally as a number of respondents take part and their distributed intelligence is structured into a coherent whole.

The present invention makes use of implicit questioning, by asking for associations, rather than directly asking what a respondent thinks of something, which is more effective at revealing that truth.

Optionally, the present invention provides a method wherein said database further comprises a third plurality of lower-level associated ideas for each of said first plurality of associated ideas and a ranking for said lower-level associated ideas, the method further comprising the additional steps of:

presenting to said respondents said subject item, one of said first plurality of associated ideas and a fourth plurality of lower-level associated ideas, said fourth plurality being a subset of said third plurality;

receiving from said respondent an input comprising a selection from said fourth plurality of lower-level associated ideas or a free input; and

updating said database by:

in the case that said input is a selection from said fourth plurality, increasing the ranking of the selected lower-level associated idea; or

in the case that said input is a free input, adding said free input as a new lower-level associated idea

The invention can thereby also provide a laddered interrogation of a respondent by successively asking the respondent for inputs on their previous answers. This gives the research tool a rudimentary form of intelligence in that it appears to react to previous answers. The questions asked are not fixed but rather fluid and responsive to previous answers. At the same time, respondents are free to say whatever they like and are not limited to precoded answers provided by the author of the questionnaire. The ranking, and optional rating process, then automatically provides a quantitative output, once sufficient respondents have participated, based on the qualitative input provided by the fact that respondents can supply free input.

Even though the respondent is allowed to supply free input, the present invention enables free associations to be self-organising through the ranking and reinforcement process. The self-organised results can be clearly and logically displayed in a mind map format.

The present invention, by providing an array of tools that can be simply set up, enables market research, idea generation and concept testing to be carried out quickly and easily, even by the non-specialist.

The present invention further provides a method of setting up a research tool for generating and evaluating feedback from a plurality of respondents, said method comprising the steps of:

presenting to a user a list of predefined research tool formats; receiving from said user a selection from said list;

presenting to a user a request for a subject description;

receiving from said user said subject description;

initialising a database comprising an identification of the selected research tool format and said subject description;

communicating to said user a URL identifying a computer program for effecting the selected research tool using said database.

An extremely simple and rapid procedure for setting up a research tool is thereby provided. The user does not need to have any expertise in market research; he or she simply needs to provide the subject and select a tool. The rest is set up automatically. A few moments only are required to provide the subject and select a tool whilst stylistic choices can be made in only a few more. This rapid set up is enabled because the question structure for each tool, though not the exact questions, is set in advance.

Preferably, the research tool utilises predetermined templates of questions and/or instructions into which the subject idea and responses from respondents are inserted. The templates can be translated in advance into a plurality of languages, amongst which the user selects. This obviates the time and cost of translating a questionnaire each time research is to be carried out. The user may also easily conduct the same research in a number of different markets using the same tool in different languages and/or may offer respondents a choice of language in which to take part.

The present invention is particularly apt for implementation via the Internet but other communications media may also be used, for example interactive television, automated telephone systems and interactive telephone systems, e.g. SMS and 3G. Programs to carry out the present invention may be written in any suitable programming or scripting language or may be integrated into any communications based software such as Lotus Notes(TM), Microsoft Frontpage(TM) or Office(TM), or .net(TM) applications, browsers such as Microsoft Internet Explorer(TM), Netscape Navigator(TM) or Macromedia Dreamweaver(TM). Pages of information and input request screens may be described and sent to the user or respondents in a convenient format or language, such as HTML or XML.

The present invention will be described further below with reference to exemplary embodiments and the accompanying schematic drawings, in which:

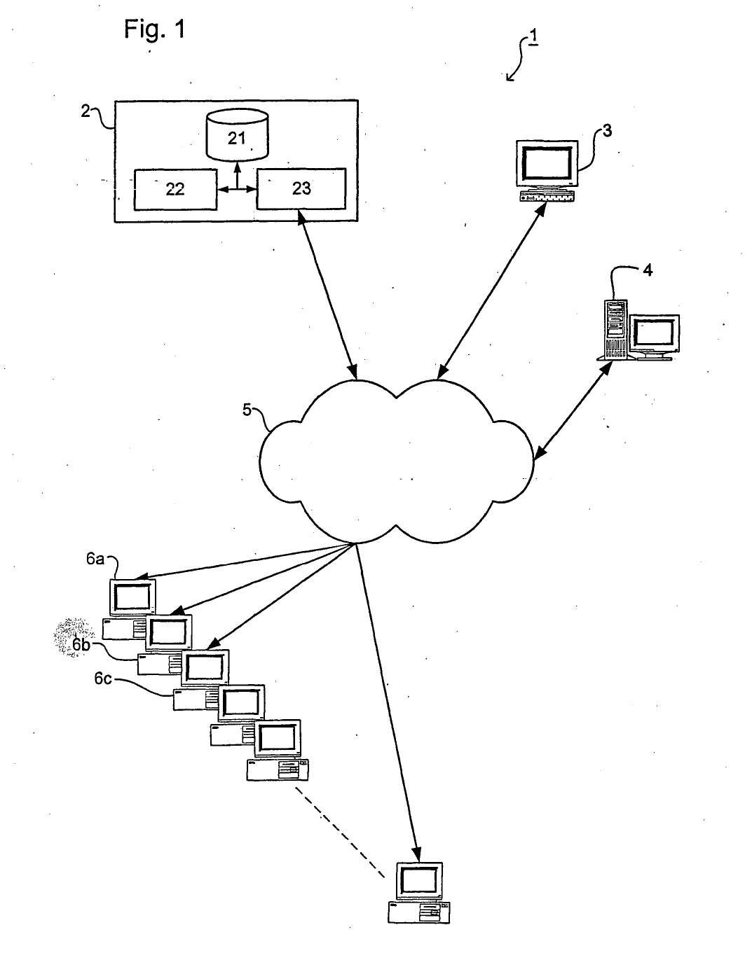

FIG. 1 depicts a system in which the method of generating and evaluating feedback according to the present invention may be employed;

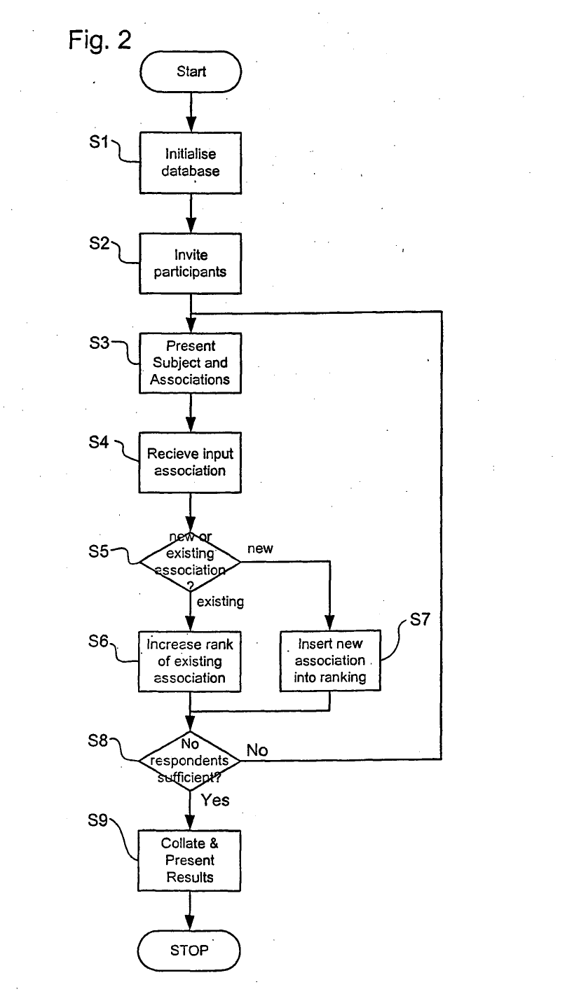

FIG. 2 is a flow diagram of the basic process of a first embodiment of the present invention;

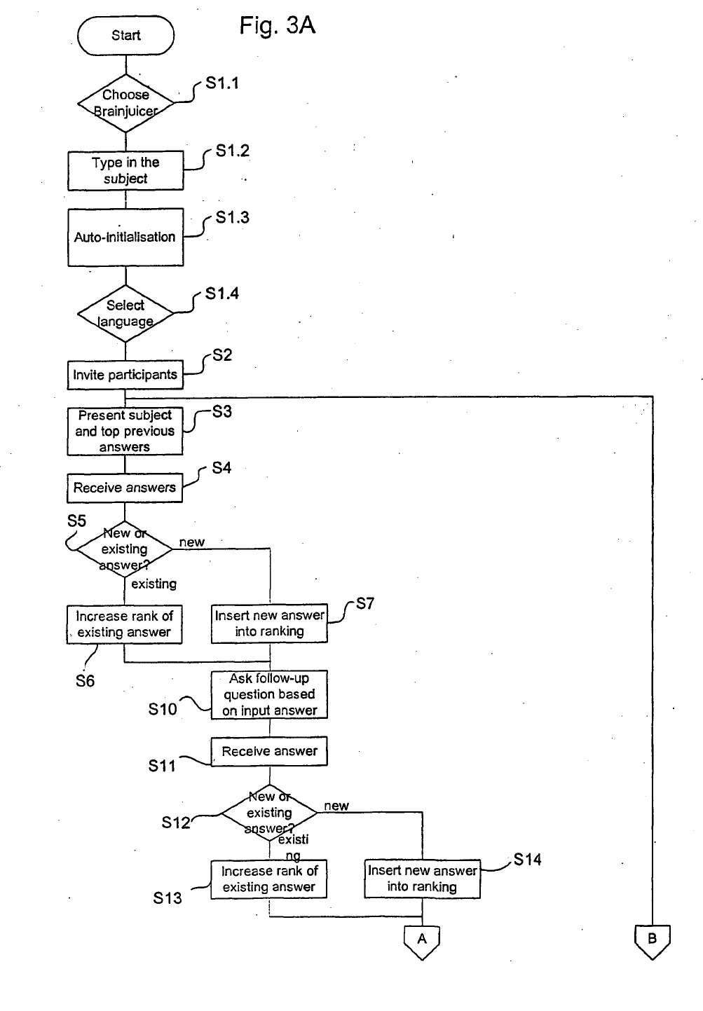

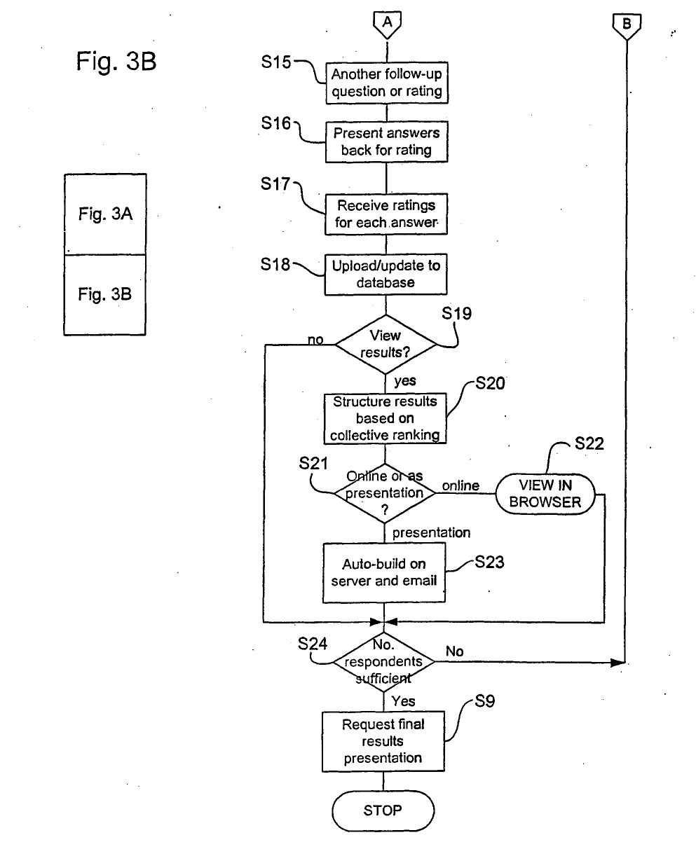

FIGS. 3A and 3B are a flow diagram of a variant of the process of the first embodiment, including additional detail and some optional additional steps;

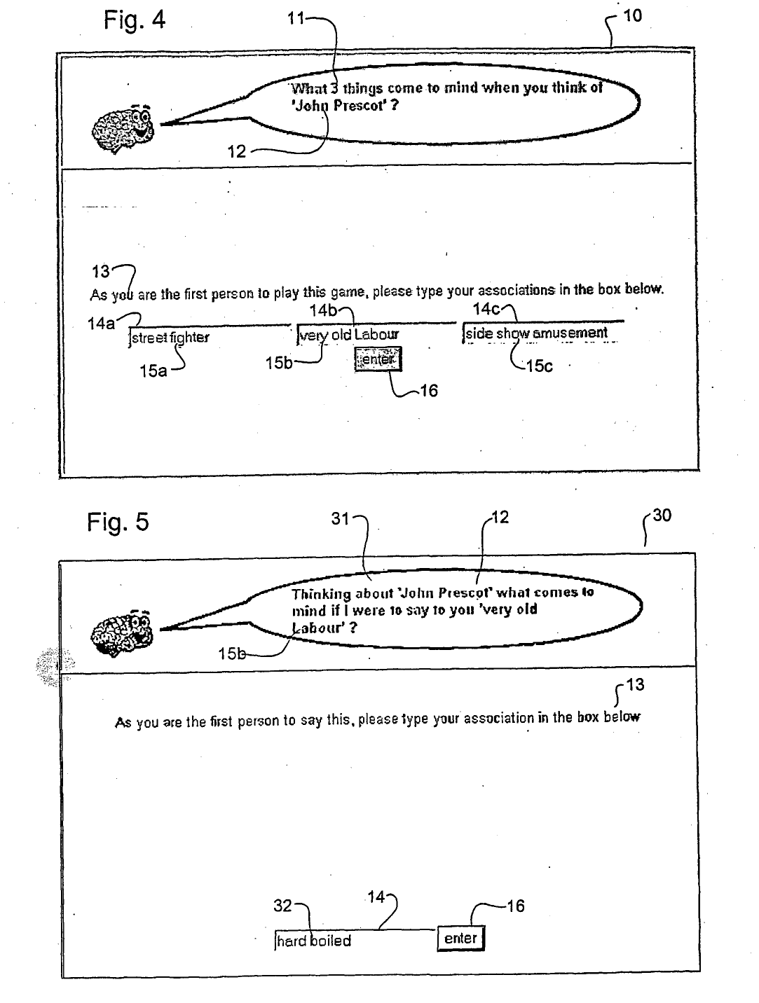

FIGS. 4 to 9 depict screen displays viewed by a respondent in the first embodiment of the present invention;

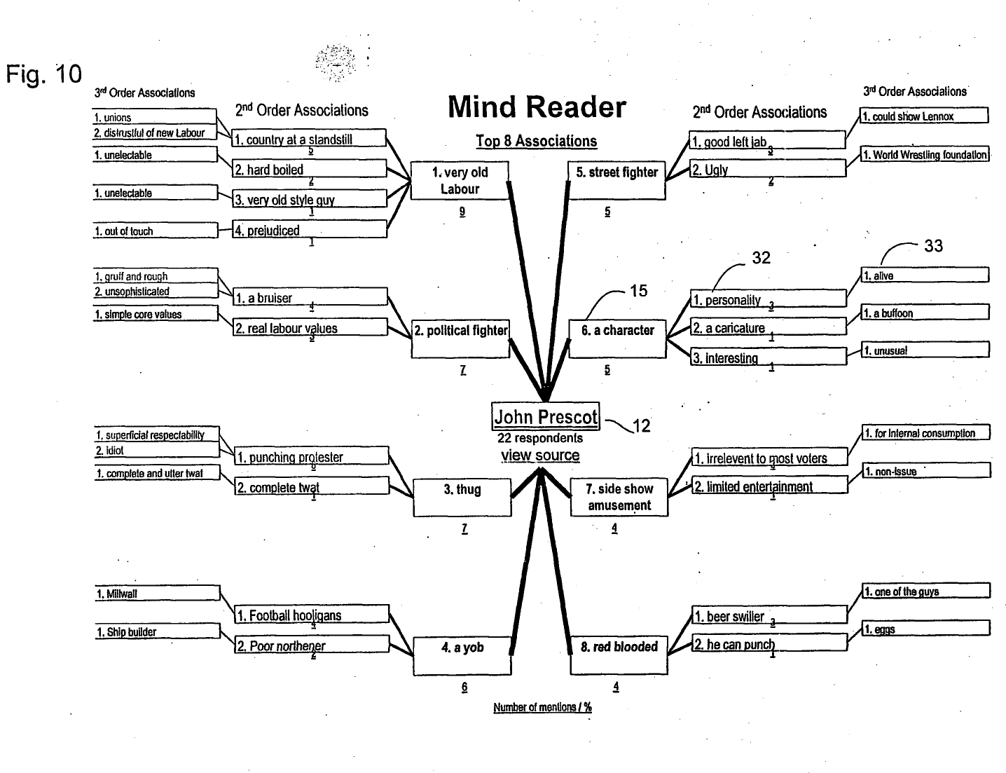

FIG. 10 depicts a mind map showing the results of a method according to the first embodiment of the present invention;

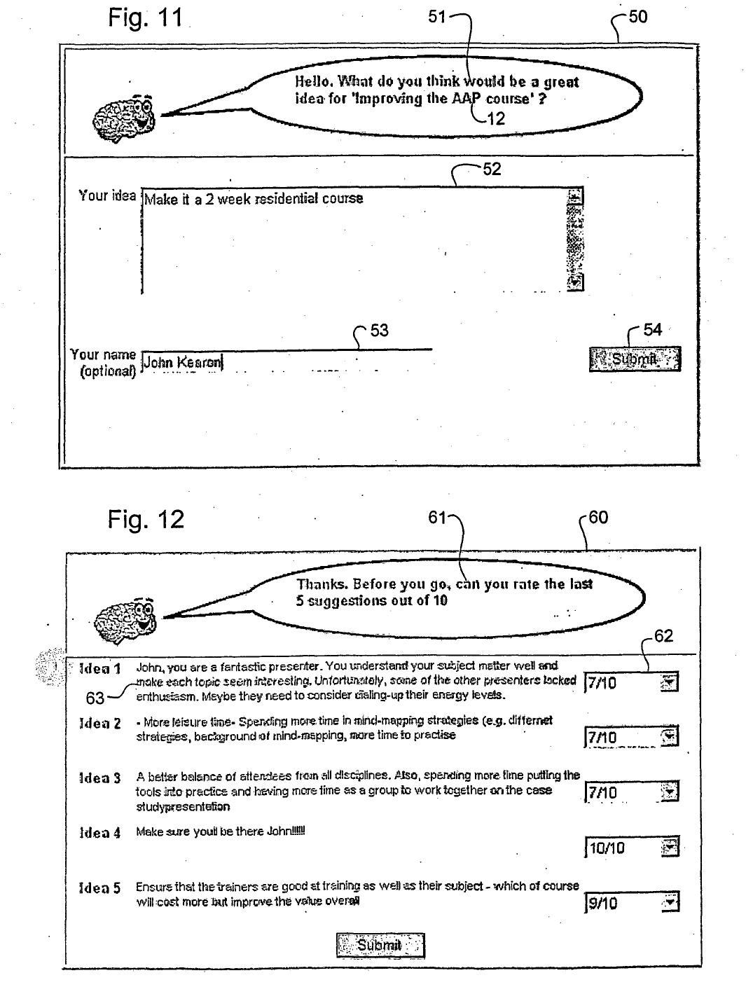

FIGS. 11 and 12 depict screen displays viewed by a respondent in a second embodiment of the present invention;

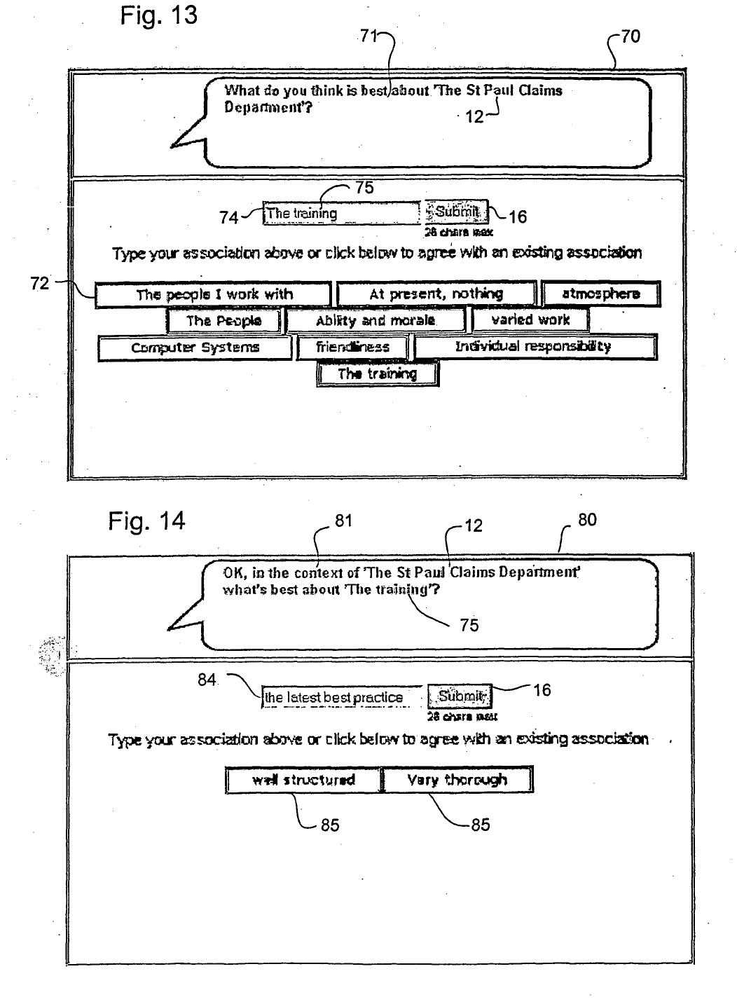

FIGS. 13 to 16 depict screen displays viewed by a respondent in a third embodiment of the invention;

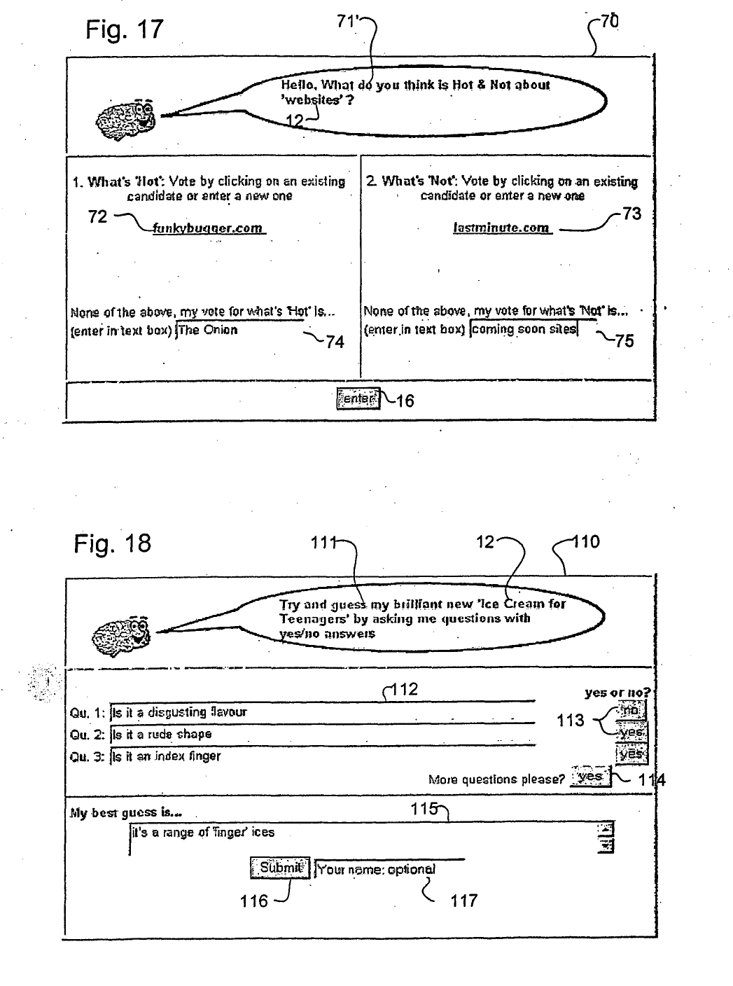

FIG. 17 depicts a screen display viewed by a respondent in a variant of the third embodiment of the invention;

FIG. 18 depicts a screen display viewed by a respondent in a fourth embodiment of the invention; and

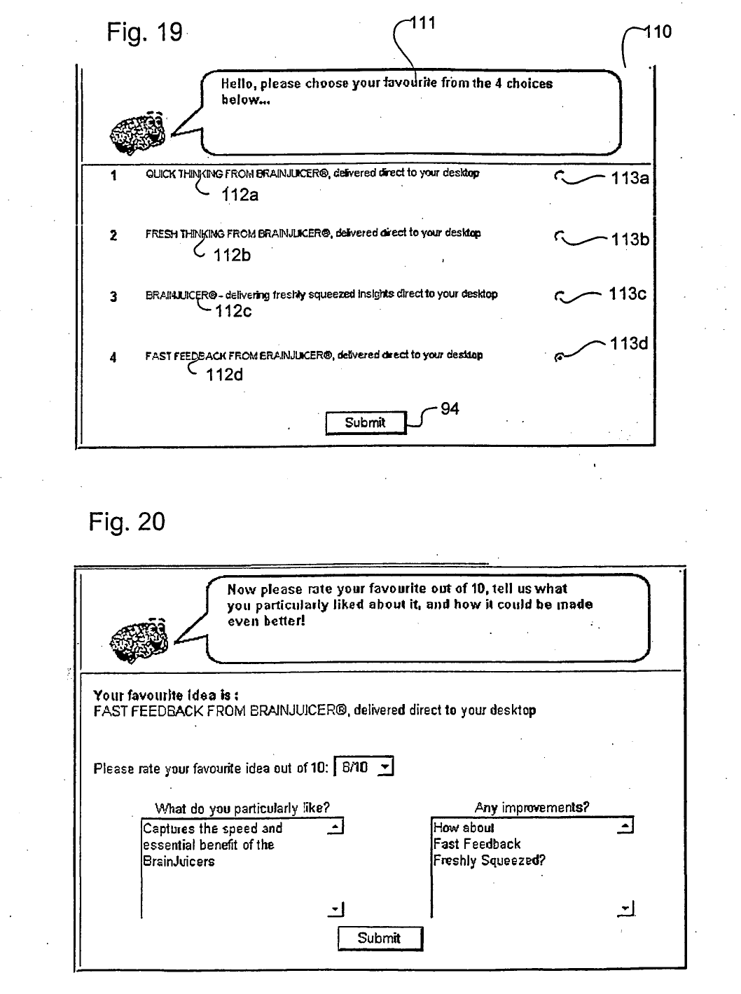

FIGS. 19 and 20 depict screen displays viewed by a respondent in a fifth embodiment of the invention.

In the various drawings, like references denote like parts.

Embodiment 1

A system 1 on which the present invention can be put into practice comprises a research server 2 which communicates with user computer 3, user server 4 and respondent computers 6a, b, c, etc. via the Internet 5. The research server 2 comprises a database 21, which is controlled and maintained by research processing module 22, and web server module 23 which generates the necessary web pages in response to requests from browser software running on user computer 3 and respondent computers 6a, b, c etc.

A flow chart of the process by which a user may generate and evaluate feedback from a plurality of respondents is shown in FIG. 2. The first step is for the user to initialise S1 the database which will be used in the process of generating and evaluating feedback and will contain the final results. This can be achieved very simply by the user directing the web browser on his computer 3 to an initialisation page provided by web server 23 on research server 2. The initialisation page provides the user with a means, e.g. a text input box, by which the user can define the research subject on which feedback is sought. The user provides a verbal description of the research subject by typing into the text input box provided. For best results, the verbal description should be succinct yet specific. For example, feedback may be sought on a named individual, product or brand. In alternative embodiments of the present invention, the subject description may be given in other media, e.g. a sound file containing an extract of a record or radio program on which feedback is sought, or an image including a company or product logo or a picture of a product Such descriptions may be used in combination with each other and with a verbal description. The subject description is stored in association database 21 as the root of the associations which will be collected during the process for generating and evaluating feedback.

During the initialisation, the user may also have the option of customising the presentation of questions in the feedback process, e.g. choosing text styles and sizes, screen colours and any graphics to be included. The user may also select the language in which the process is to be presented from a list of languages into which the question and instruction templates have previously been translated.

The next stage is to invite S2 participants to give their feedback on the research subject. Respondents will give their feedback via an automated process invoked by a request to a URL specific to the research subject. To invite respondents to participate it is necessary to communicate that URL to them. This can be done by providing a link on the user's website, maintained by user's web server 4, particularly if the website is, or carries information on, the research subject. Visitors to the user's website may therefore become respondents to the feedback method by selecting the appropriate link on the user's website. Although this link may redirect the respondent's browser to research server 2, this may be done seamlessly so that the respondent is unaware of the transfer. The URL by which users will access the feedback method may also be included in e-mail, generated manually or automatically, so as to invite feedback from specific respondents. The URL may also be included in other media such as printed material and/or broadcasts. When a respondent requests via its web browser the URL identifying the feedback tool, the web server 23 initiates a procedure to obtain feedback from that respondent. This procedure may be effected by presentation to the user of a series of web pages, e.g. constructed on the fly, or by downloading to the user a computer program (applet), e.g. written in JavaScript™, which will execute on the respondent's computer 6a, b, c, etc. to effect the entire feedback process. In either case, the feedback process comprises the same steps S3 to S7 shown in FIG. 2.

As a first step the respondent is presented S3 with the subject description and is requested to provide a predetermined number, e.g. three, of associations that spring to mind when the subject description is read. In the case of the first respondent, no previous association with the subject will be stored in the database 22 and so the first respondent is requested to provide three items of free input, and this may be done via a screen display 10 as shown in FIG. 4.

The screen display 10 comprises a question 11 linked to the subject description 12 inviting the respondent to provide associations. A context specific instruction 13 directs the respondent to type his/her associations 15a, b, c into three text entry boxes 14a, b, c. In the state shown in the Figure, this has been done. Finally, an “enter” button 16 is provided for the respondent to confirm his/her input is complete.

To obtain further depth of feedback from the respondent, the respondent is asked to provide further association with their first-level association (i.e. the association brought to mind by the research subject done) in the context of the research subject. This optional refinement of the process, along with some additional details, is shown in FIGS. 3A & B, which is an expanded version of the flow chart of FIG. 2. If the respondent's first-level association was a selection of an existing association rather than a free input, the respondent is presented at step 10 with previous respondents second-level associations to that first-level association as well as the option to provide free input to that association. Optionally, subsequent respondents may be invited to give their associations with earlier respondents' first-level associations. The second level associations are received S11 and processed S12-S14 in the same way as the first level associations. The procedure may continue further, with the respondents' associations to the first-level associations in the context of the research subject forming second-level associations and respondents being asked for third-level associations with the second-level associations in the context of the first-level associations and the research subject. A screen display 30 requesting second-level associations from the first respondent is shown in FIG. 5. In this display, the question 31 includes the subject description 12 as well as a first-level association 15b. The instruction 13 directs the respondent to enter an associations 32 in the text entry box 14.

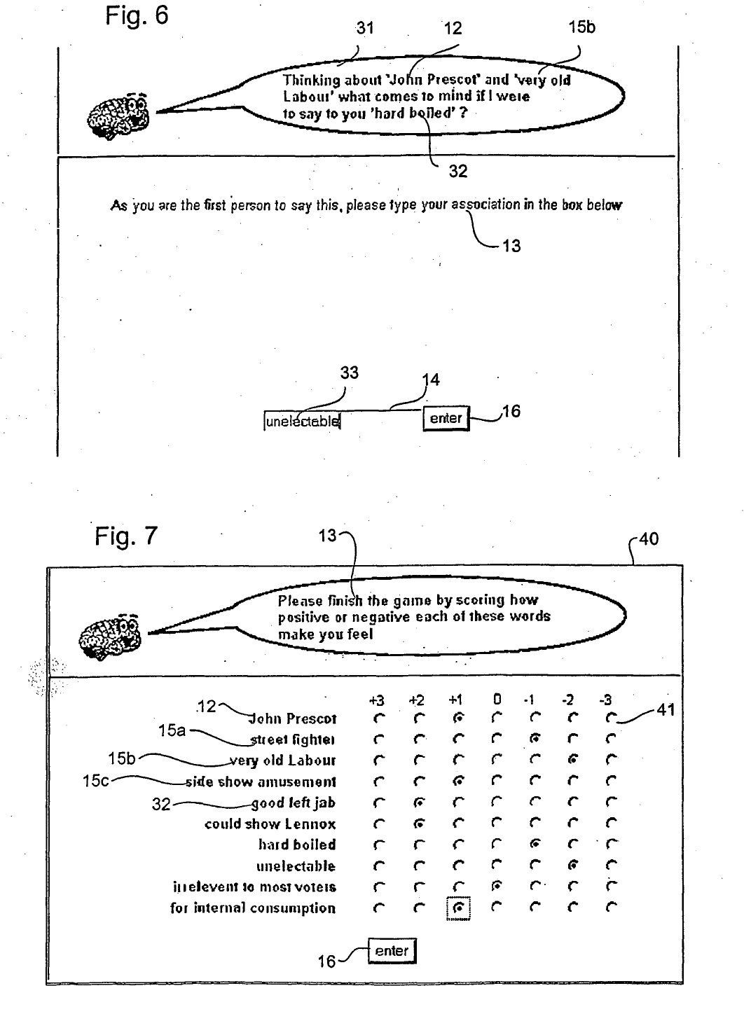

FIG. 6 then shows the display asking for a third level association 33 in the context of the subject 12, first level association 15b and second level association 32.

To complete the feedback, the respondent may be asked to provide a rating of how positive or negative the research subject and some or all of their first-, second- and third-level associations makes them feel, steps S15-S17. This can be done via screen display 40 having a grid of selection boxes 41 as shown in FIG. 7. Demographic information, e.g. age and sex, may also be requested from the respondent.

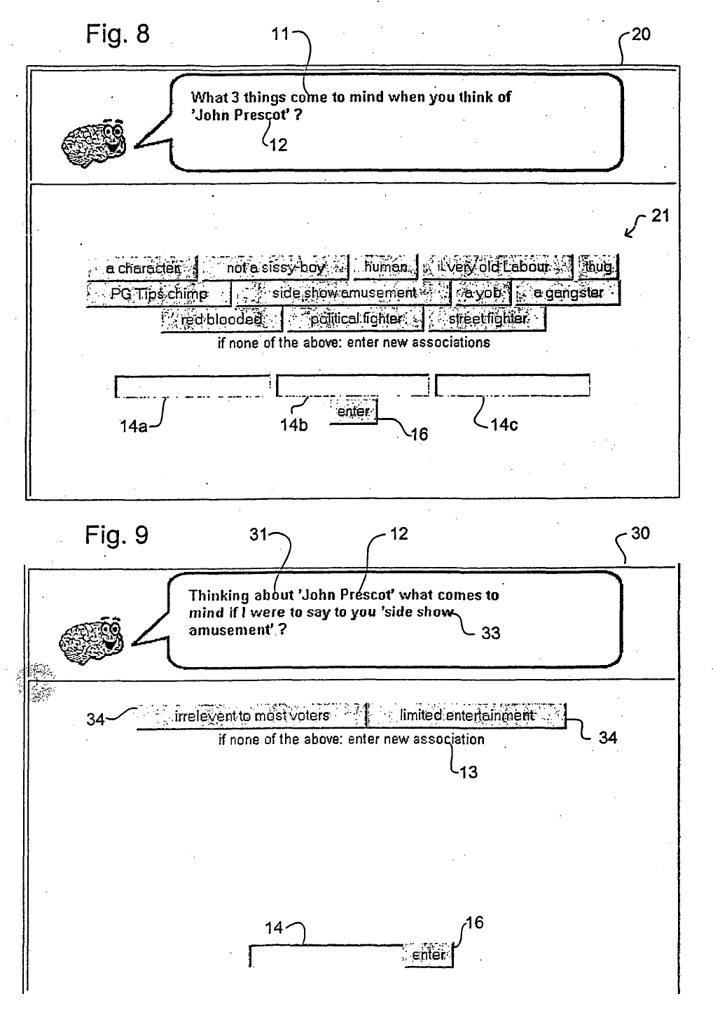

For subsequent respondents, associations previously input by earlier respondents are also displayed and the respondent is invited to select from the previous associations and/or provide free input. A suitable screen display 20 for this is shown in FIG. 8. In this arrangement the previous associations are presented as labelled buttons 21 and pressing one of the buttons causes the corresponding text to be copied into the first empty text input box 14a, b, c below. The user may edit the text thus copied into the text input box or type from scratch into an empty text input box so as to provide free input.

FIG. 9 shows a screen display for the case when the current respondent has selected an existing first-level association 33 to the research subject 12 and is asked, by question 31, for a second-level association. The display includes existing second-level associations presented as labelled buttons 34 as well as a text box 14 for free input.

At each stage, the selected or free input associations of the respondent are communicated to the research server 2; this may be done immediately the user presses the “enter” or “submit” buttons 15, 16 provided on the displays shown in the Figures or may be saved until completion of the whole process for obtaining further depth of associations described below.

When the respondent's input association is received, whether it is a first-, second- or third-level association, it is determined S5, S12 whether such association represents a selection of a previous association or the input of a new association In the case where the respondent has selected an existing association, that association is given an increased ranking S6, S13 in the database 21. On the other hand, where the respondent has input a new association, that association is inserted into the database and given an initial ranking S7, S14. The selection of associations to present along with the initial subject (or higher level associations) is based on the ranking of associations in the database when the respondent begins the feedback process.

In a preferred algorithm for selecting associations to display, the research server 22 maintains a list of preferred associations, e.g. eight in number, which represents the highest ranked associations within the database, and a contender list, again e.g. eight in number, of the most recent new associations and the association most recently demoted from the preferred list.

When the research subject is displayed to a respondent the associations of both the preferred list and the contender list are also displayed, preferably in a random order and without the user being able to identify which is which to avoid any bias. If one of the associations on the contender list is selected before the lowest-ranked association on the preferred list, the selected association from the contender list is promoted to the preferred list, taking the place of the previously lowest-ranked association on the preferred list and adopting its score. The replaced association from the preferred list is then added to the contender list. If however the lowest-ranked association from the preferred list is selected before any association from the contender list, the contender list is cleared. If any other association from the preferred list is selected, its score, on which its ranking is based, is incremented by a predetermined amount

When a new association is entered as free input, that association is added to the contender list, replacing the oldest association in the contender list if the contender list is already full.

The same algorithm is used to manage preferred and contender lists of second- and third-level associations for each of the higher level associations. However the preferred and contender lists may be restricted, e.g. to four members each for the second-level associations and two members each for the third-level associations.

Alternatively, or in addition to asking for multiple levels of association, the respondent maybe asked one or more follow-up questions, e.g. of the nature of “what do you think of this process”, which may require answering by selection from alternatives or by free input.

Each respondent maybe given the opportunity S19 to view the results of their participation, possibly alongside the collated results of previous respondents. The respondent may select S21 to view the results in their browser, in which case an HTML or XML page is generated and sent to the respondent S22 or as a presentation, which is e-mailed to an address provided by the respondent.

When a sufficient number of respondents have provided their feedback, or a predetermined time for responses has elapsed, the results are automatically collated and presented S9. The results may be presented in one of a number of forms. In the simplest, the results are presented in a table provided in an HTML or XML page. The first-level associations are presented in rank order along with their respective second- and third-level associations. The scores on which the ranking of the associations is based may also be displayed as can the average rating of how positive or negative respondents felt about the research subject and associations.

Alternatively, the results can be automatically displayed in the form of a mind map as shown in FIG. 10. In the mind map, the subject description 12 is placed centrally with the first-, second- and third-level associations forming a tree structure around it. The first-level associations are presented in ranked order, 1 to 8, and their score and average positive/negative rating also given. The second- and third-level associations are also displayed in ranked order with their average positive/negative rating. The ratings of associations may also be indicated by colour-coding the associations or the blocks in which they are written. Ideally, the mind map is structured to display or print on a single screen or sheet of paper, e.g. A4 or similar. Additionally, the results can automatically be processed into a format for presentation via an application such as PowerPoint(TM).

Embodiment 2

A second embodiment of the present invention is specifically adapted to elicit and score suggestions from the respondents. The underlying mechanism for obtaining and processing results is the same as the first embodiment but the screen displays presented to respondents differ. As shown in FIG. 11, for the method of the second embodiment, each respondent is presented with a screen display 50 with a question 51 aimed at eliciting suggestions about the subject description 12. The display also includes a large text input box 52 into which the respondent may type their suggestion and a smaller text input box 53 allowing respondents, if desired, to give their names. Finally, a “submit” button 54 is included. Having submitted their suggestion, users are presented with a second display 60, shown in FIG. 12, in which they are requested by question 61 to rate some, e.g. five, previous suggestions out of ten. This can be easily effected by providing pull-down boxes 62 adjacent each previous suggestion 63.

In this embodiment, the blind variation, generative step of the evolutionary algorithm takes the form of the free input of ideas by respondents. Selective retention is provided by the rating of previous responses from which a hierarchy of the suggestions based on popularity can be derived. Just as with the first embodiment, follow-up questions can be asked, based on the respondents' selections.

Embodiment 3

A third embodiment of the present invention is adapted to elicit from respondents their views as to what is best and worst about the research subject A screen display 70 to elicit what the respondent thinks is best about the subject is shown in FIG. 13. Question 71 asks respondents to select or enter what is thought to be the best aspect or item relating to the research subject description 12. This is effected by providing buttons 72 of previous nominations for best, a respective text input box 74 and a submit button 16. Each of buttons 72 acts to copy that entry into the text input box 74, as shown at 75, where it may be edited by the respondent Alternatively, the respondent may type directly into the text input box 74 to enter a new nomination.

The buttons at 72 displaying previous nominations are arranged using the evolutionary algorithm described in relation to the first embodiment Transparently to the respondent, the displayed buttons 72 consist of the entries from preferred and contender lists, randomly arranged. Selection of a nomination from the preferred list increases its ranking whilst selection of a nomination from the contender list promoted it to the preferred list in exchange with the lowest ranked member of that list. Selection of the lowest ranked member of the preferred list clears the content list. New associations entered as free input are entered on the contender list, replacing the oldest entry if the contender list is full.

Having selected the best and worst aspects of the research subject, the respondent is then asked what is best about the best aspect of the research subject, for example via the screen displays in FIG. 14. Question 81 mentions the research subject 12 and the previously selected answer 75. Text box 84 is provided for free input and previous answers 82 are displayed on buttons 85 for selection. The answer to this request is also the subject of a further level of inquiry, producing three levels of information about the best aspects of the research subject.

In each level of inquiry, the respondent is given the option of selecting from a list of previous respondents' inputs or providing free input. The lists of previous input can be managed using the same algorithm as in the first embodiment.

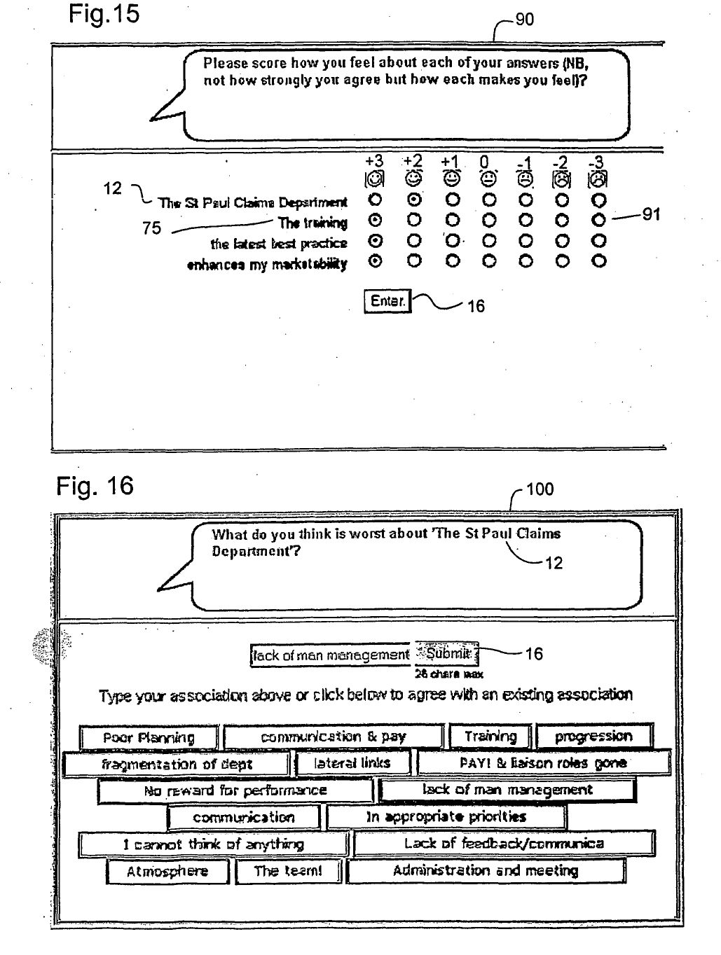

A final step can be to ask the respondents to rate how they feel about their previous answer, e.g. via a screen 90 shown in FIG. 15. This displays the research subject 12 as well as a previous answer 75 and a grid 91 for the respondents to select their ratings.

The process of eliciting what is worst follows a corresponding process. FIG. 16 shows a screen display 100 for the first step of this; the remaining steps may use displays corresponding to those used for best.

In a variant of the third embodiment, the user is asked to nominate what is “hot” and what is not, about the research subject, a screen display 70′ for this is shown in FIG. 17. This screen display is functionally the same as that of FIG. 12, principally differing in the phrasing of question 71′.

The valiant of the third embodiment also differs in the procedure after the respondent has given his/her initial response. In the variant, rather than entering a recursive series asking what is best or worst about the previous answer, the respondent is asked for three associations with their selected or input “hot” and “not” nominations. This process is carried out in the same manner as the first embodiment.

Embodiment 4

A fourth embodiment of the present invention is adapted to foster the generation of new ideas or inventions by respondents. The fourth embodiment can be carried out using a simple screen display 110 as shown in FIG. 18.

The screen display 110 includes a question 111 which directs respondents to guess a new idea within the research subject description 12 by asking questions which may be answered yes or no. The respondent enters those questions in text input boxes 112 and as each question is complete, a yes or no answer 113 is displayed. The respondent continues asking question, requesting space for more questions via button 114 if necessary, until he/she believes he/she knows the answer in which case he/she enters this in text input box 115 and presses submit button 116. The respondent may also provide his/her name in text input box 117.

In truth, there is no pre-existing idea to be guessed; the yes/no answers are generated randomly and stimulate the respondents to come up with their own ideas which they enter into the guess box 115.

Once an idea has been entered, the user is presented with the previous five ideas and asked to rank them, in the same manner as with the suggestions box of the second embodiment.

In this embodiment, similarly to the second embodiment, blind variation is provided by the free input of guesses by respondents and the rating of previous respondents' guesses.

Embodiment 5

A fifth embodiment of the invention is designed to test the popularity of a number of predetermined subjects whilst obtaining some information as to reasons for a given subject's popularity.

The first step is to obtain the respondent's selection of the preferred one of a list of predetermined subjects. This is done via screen display 120 shown in FIG. 19. In addition to a simple name of the subjects, an image or logo or a longer description can be displayed. To avoid bias arising from the order in which the subjects are displayed, they may be displayed in a random order to each respondent. Question 121 directs the respondent to select one of the predetermined subjects 112a-d by marking the respective selection box 122a-d and the selection is communicated to research server 2 by clicking on submit button 16.

The second step in this embodiment is to obtain some feedback as to the reasons for the respondent's selection. This can be achieved by asking the respondent to give a numeric rating, e.g. using a display such as shown in FIG. 20 or by using the best/worst process of embodiment 3 with the selected one of the predetermined subjects forming the research subject of the best/worst question. The respondent can also be provided with an opportunity to provide comments on the selected subject as free input.

Embodiment 6

The sixth embodiment provides a system for allowing users to quickly set up and maintain a research tool to be answered by a plurality of respondents.

The process for setting up a research tool for a given subject is very simple. The user visits a page hosted by research server 2 which presents as option the different research texts of embodiments 1 to 5 described above, or variants there The user selects one of the tools as appropriate for the type of research sought and is then prompted for the research subject description (or subject descriptions in the case of the research tool of embodiment 5) and the number of respondents to be processed and/or the length of time the tool is to be open for research. The user may also be given the option of customising the appearance of the screen displays to be used.

The research processor 22 then initialises a database 21 for the research tool and generates a URL for the research tool. This URL is communicated to the user for overall communication, e.g. via the user's website or via e-mail, to the respondents. The research processor 22 also responds to requests from the user to provide updates on the progress of research, e.g. an indicator of the number of respondents who have completed the process and/or interim reports of results.

Whilst we have described above specific embodiments of the present invention it will be appreciated that variations may be made within the scope of the invention, which is defined in the appended claims. For example, the research of the different embodiment tools may also be combined in various presentations. In one case, respondents may be first asked for associations with their subject items and then for what is best/worst about those associations.

1. An automated method for generating and evaluating feedback from a plurality of respondents, the method comprising the steps of:
providing a database containing at least one subject item, a first plurality of ideas associated with said subject item, and a ranking of said associated ideas;
presenting to one of said respondents said subject item and a second plurality of associated ideas with said subject item, said second plurality comprising a subset of said first plurality based on said ranking;
receiving from said respondent an input comprising a selection from said second plurality of associated ideas or a free input;
updating said database by:
in the case that said input is a selection from said second plurality of associated ideas, increasing the ranking of the selected associated idea, or
in the case that said input is a free input, adding said free input as a new associated idea; and
repeating the steps of presenting, receiving and updating to generate and evaluate feedback from said plurality of respondents.

2. A method according to claim 1 wherein said database further comprises a third plurality of lower-level associated ideas for each of said first plurality of associated ideas and a ranking for said lower-level associated ideas, the method further comprising the additional steps of:
presenting to said respondents said subject item, one of said first plurality of associated ideas and a fourth plurality of lower-level associated ideas, said fourth plurality being a subset of said third plurality;
receiving from said respondent an input comprising a selection from said fourth plurality of lower-level associated ideas or a free input; and
updating said database by:
in the case that said input is a selection from said fourth plurality, increasing the ranking of the selected lower-level associated idea; or
in the case that said input is a free input, adding said free input as a new lower-level associated idea.

3. A method according to claim 2 wherein in the additional step of presenting, said one of said first plurality of associated ideas is an associated idea selected or entered by said respondent.

4. A method according to claim 3 wherein said additional steps of presenting, receiving and updating are repeated for each associated idea selected or entered by said respondent.

5. A method according to claim 1 wherein said database further comprises:
a first list of associated ideas comprising a second predetermined number of associated ideas of the highest ranked of said first plurality of associated ideas; and
a second list of associated ideas comprising up to a third predetermined number of associated ideas;
and wherein said second plurality of associated ideas consists of said first and second lists of associated ideas;
and wherein said step of updating comprises:
in the case that said input comprises a free input, adding said free input to said second list and if said second list previously had said third predetermined number of members, deleting from said second list the previous member that was added to said second list earliest;
in the case that said input comprises a selection of an associated idea from said second list of associated ideas, exchanging the selected associated idea with the lowest ranked member of said first list; and
in the case that said input comprises a selection of the lowest ranked member of said first list, deleting all members from said second list.

6. A method according to claim 1 further comprising, prior to said step of presenting said subject item and a second plurality of associations, the steps of:
presenting to said respondent a plurality of subject items; and
receiving from said user a selection from said plurality of subject items, said selected subject items being used as said subject item for the remainder of said method.

7. A method according to claim 1 wherein said step of receiving comprises receiving a first predetermined number of selections and/or items of free input from said respondent.

8. A method according to claim 7 wherein said first predetermined number is three.

9. A method according to claim 1 comprising the further steps of:
presenting to said respondent said subject idea and at least one of said associations and requesting said respondent rate said subject idea and the presented associations; and
receiving as input said respondent's ratings of said subject idea and the presented associations.

10. A method of generating and evaluating feedback from a plurality of respondents, the method comprising the steps of:
establishing a database comprising a plurality of subject items, each having an associated ranking;
presenting to one of said respondents a subset of said plurality of subject items, said subset being selected on the basis of the rank of said subject items;
receiving as input from said respondent a selection of one of said subset or a free input;
updating said database by:
in the case that said input is a selection from said subset, increasing the ranking of the selected subject item, or
in the case that said input is a free input, adding said free input as a new subject item; and
repeating the steps of presenting, receiving and updating to generate and evaluate feedback from said plurality of respondents.

11. A method according to claim 10 wherein said database further comprises:
a first list of subject items comprising a first predetermined number of the highest ranked of said subject items; and
a second list of subject items comprising up to a second predetermined number of subject items;
and wherein said subset consists of said first and second lists of subject items;
and wherein said step of updating comprises:
in the case that said input comprises a free input, adding said free input to said second list and if said second list previously had said third predetermined number of items, deleting from said second list the previous item that was added to said second list earliest;
in the case that said input comprises a selection of an subject item from said second list of subject items, exchanging the selected subject item with the lowest ranked member of said first list; and
in the case that said input comprises a selection of the lowest ranked member of said first list, deleting all members from said second list.

12. A method of generating and evaluating feedback from a plurality of respondents, the method comprising the steps of:
presenting to a current respondent a request for input;
receiving from said current respondent a free input item;
presenting to said respondent free input items received from previous respondents and requesting said current respondent rate said free input items received from previous respondents;
receiving ratings from said current respondents;
repeating the previous steps for a plurality of respondents; and
ranking said free input items on the basis of the ratings.

13. A method according to claim 1, further comprising the step of automatically collating and presenting the feedback results from said plurality of respondents.

14. A method according to claim 13 wherein said feedback results are presented as a table in an HTML page, a mind map or a presentation file.

15. A method according to claim 14 wherein said mind map comprises a tree structure with said subject idea forming the trunk of said tree and said associated ideas forming branches.

16. A method according to claim 15 wherein said mind map further comprises said rankings displayed in association with said associated ideas.

17-18. (Cancelled)

19. A method of setting up a research tool for generating and evaluating feedback from a plurality of respondents, said method comprising the steps of:
presenting to a user a list of predefined research tool formats;
receiving from said user a selection from said list;
presenting to a user a request for a subject description;
receiving from said user said subject description;
initialising a database comprising an identification of the selected research tool format and said subject description; and
communicating to said user a URL identifying a computer program for effecting the selected research tool using said database.

20. A method according to claim 19 wherein at least one of said research tool formats is a method according to claim 1.

21. A method according to claim 19 wherein each of said research tool formats includes a template into which, in use, said subject description and/or responses from respondents are inserted, the method comprising the further steps of:
presenting to the user a list of languages into which said template has previously been translated;
receiving from said user a selected language from said list of languages; and
including information identifying said selected language in said database.

22. A method according to claim 1 wherein said step of presenting comprise generating an HTML or XML, Java or Javascript file and transmitting it onto the Internet for delivery to said respondent.

23. A method according to claim 1 wherein said subject item comprises a verbal description, a still or moving image and/or audio data.

24-27. (Cancelled)

28. A method according to claim 10, further comprising the step of automatically collating and presenting the feedback results from said plurality of respondents.

29. A method according to claim 12, further comprising the step of automatically collating and presenting the feedback results from said plurality of respondents.

30. A computer readable storage medium having recorded thereon program code means for instructing a computer system to generate and evaluate feedback from a plurality of respondents, by providing a database containing at least one subject item, a first plurality of ideas associated with said subject item, and a ranking of said associated ideas;
presenting to one of said respondents said subject item and a second plurality of associated ideas with said subject item, said second plurality comprising a subset of said first plurality based on said ranking;
receiving from said respondent an input comprising a selection from said second plurality of associated ideas or a free input;
updating said database by:
in the case that said input is a selection from said second plurality of associated ideas, increasing the ranking of the selected associated idea, or
in the case that said input is a free input, adding said free input as a new associated idea; and
repeating the steps of presenting, receiving and updating to generate and evaluate feedback from said plurality of respondents.
